(19) United States
(12) Patent Application Publication
(10) Pub. No.: US 2020/0346381 A1
(43) Pub. Date: Nov. 5, 2020

(54) MOLD, EJECTION STRUCTURE THEREOF AND MANUFACTURING METHOD OF FAN

(71) Applicant: Delta Electronics Components (Wujiang) Ltd., Wujiang (CN)

(72) Inventors: Shenghua LUO, Wujiang (CN); Huilin ZHAO, Wujiang (CN)

(73) Assignee: Delta Electronics Components (Wujiang) Ltd., Wujiang (CN)

(21) Appl. No.: 16/861,755

(22) Filed: Apr. 29, 2020

(30) Foreign Application Priority Data
Apr. 30, 2019 (CN) 201910363670.2
Apr. 21, 2020 (CN) 202010319158.0

(51) Int. Cl. B29C 45/40; B29C 45/00

(52) U.S. Cl. CPC B29C 45/401; B29L 2031/08; B29C 45/0025

(57) ABSTRACT

A mold for manufacturing a fan including a fixed portion and a plurality of blades connected to the fixed portion. Each of the blades has a bottom surface. The mold includes a body and an ejection structure. The body has a cavity with a shape matched with a shape of the fan. The ejection structure includes a plurality of ejection pins radially arranged. Each of the ejection pins has a working surface. Wherein a sum area of the working surfaces of the ejection pins is greater than or equal to 40% of a sum area of the bottom surfaces of the blades.

### CROSS REFERENCE

This application is based upon and claims priority to Chinese Patent Application No. 201910363670.2, filed on Apr. 30, 2019; and No. 202010319158.0, filed on Apr. 21, 2020, the entire contents thereof are incorporated herein by reference.

### TECHNICAL FIELD

This disclosure relates to a mold, an ejection structure thereof and a manufacturing method of fan.

### BACKGROUND

Dimension of an electronic product such as a notebook computer is intended to be gradually smaller. In order to meet demand for a thin electronic product, fans for dissipating heat from the electronic products are also necessarily developed thinner, and the thin fans have relatively fine blades.

The fan is generally manufactured by injection molding process. The mold used in the injection molding process mainly includes a mold body and an ejection structure. The ejection structure plays a major role of ejecting the fan that has been formed by injecting plastic solidification in the mold cavity. The fan ejected by using the traditional ejection structure will leave pits on the blades, which on the one aspect will affect the aesthetics, on the other aspect, also affect the structural strength of the blades. More importantly, when the thin fans are manufactured by using the traditional ejection structure, since blades are small and easy to deform and even unable to bear the propping force of the ejection pins to be broken, the yield of the thin fans manufactured by using the traditional ejection structure is low, even it is difficult to manufacture the thin fan.

Those contents as disclosed in the Background portion are merely used to reinforce understanding of the background technology of the present disclosure, accordingly the Background portion may include information that does not constitute the related art as already known by an ordinary person skilled in the art.

### SUMMARY

According to one aspect of the present disclosure, there is provided with a mold for manufacturing a fan. Wherein the fan includes a fixed portion and a plurality of blades connected to the fixed portion. Each of the blades has a bottom surface. The mold includes a body and an ejection structure. The body has a cavity with a shape matched with a shape of the fan. The ejection structure includes a plurality of ejection pins radially arranged. Each of the ejection pins has a working surface. Wherein a sum area of the working surfaces of the ejection pins is greater than or equal to 40% of a sum area of the bottom surfaces of the blades.

According to another aspect of the present disclosure, there is provided with an ejection structure for manufacturing a fan. The fan includes a fixed portion and a plurality of blades connected to the fixed portion. Each of the blades has a bottom surface. The ejection structure includes a plurality of ejection pins radially arranged, and each of the ejection pins has a working surface. Wherein a sum area of the working surfaces of the ejection pins is greater than or equal to 40% of a sum area of the bottom surfaces of the blades.

According to another aspect of the present disclosure, there is provided with a manufacturing method of a fan. The fan includes a fixed portion and a plurality of blades connected to the fixed portion. Each of the blades has a bottom surface. Wherein the manufacturing method of the fan includes:

providing a mold, wherein the mold includes a body, and the body has a cavity with a shape matched with a shape of the fan;

providing an ejection structure, wherein the ejection structure includes a plurality of ejection pin radially arranged, each of the ejection pins has a working surface, and a sum area of the working surfaces of the ejection pins is greater than or equal to 40% of a sum area of the bottom surfaces of the blades;

filling fluid material into the cavity of the mold;

driving the ejection structure to move along the cavity to eject solidified fluid material to form a fan.

### BRIEF DESCRIPTION OF THE DRAWINGS

The above and other features and advantages of the present disclosure will become more apparent from exemplary embodiments thereof described in detail with reference to the accompanying drawings.

FIG. 1 is a schematic perspective view of a fan;

FIG. 2 is a schematic perspective structural view of a mold device for mounting the mold of the present disclosure;

FIG. 3 is a side view of FIG. 2;

FIG. 4 is a schematic perspective structural view of an implementation of a mold according to the present disclosure;

FIG. 5 is a schematic perspective structural view of an implementation of the ejection structure according to the present disclosure, as viewed from one angle;

FIG. 6 is a schematic perspective structural view of an embodiment of the ejection structure of the present disclosure, as viewed from the other angle;

FIG. 7 is a partial enlarged view of the ejection structure shown in FIG. 6;

FIG. 8 is a schematic view of respective states of a method for manufacturing a fan according to the present disclosure;

FIG. 9 is a flow chart of a method for manufacturing a fan according to the present disclosure.

### DETAILED DESCRIPTION

Now, the exemplary implementations will be described more completely with reference to the accompanying drawings. However, the exemplary implementations can be done in various forms and should not be construed as limiting the implementations as set forth herein. Instead, these implementations are provided so that this disclosure will be thorough and complete, and concept of the exemplary implementation will be fully conveyed to those skilled in the art. Same reference numbers denote the same or similar structures in the figures, and thus the detailed description thereof will be omitted.

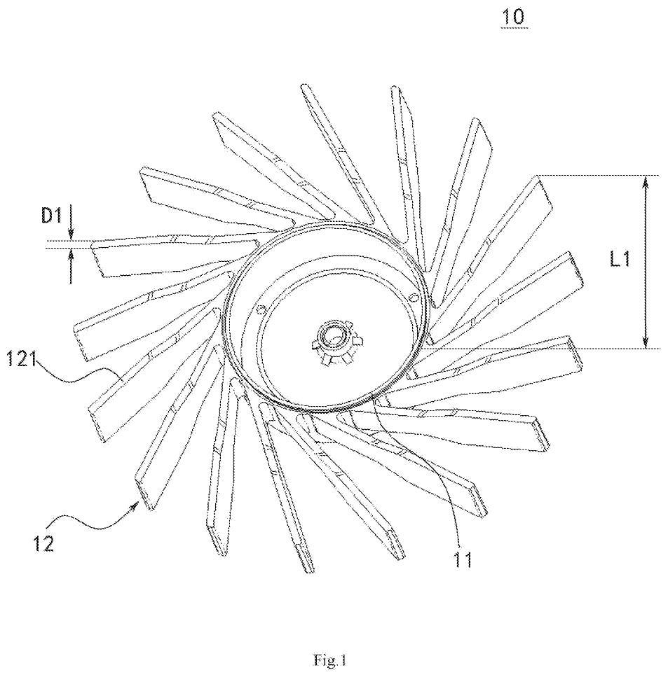

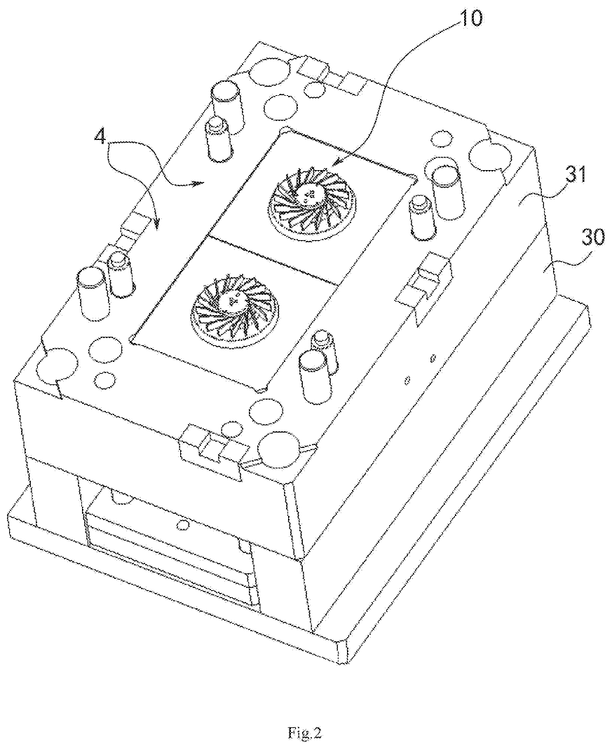

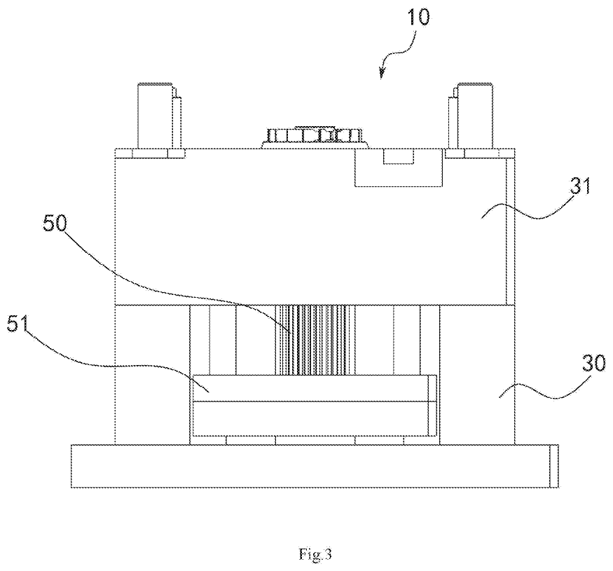

Referring to FIGS. 1, 2 and 3, FIG. 1 is a schematic perspective view of a fan 10. FIG. 2 is a schematic perspective structural view of a mold device for mounting the mold 4 of the present disclosure; FIG. 3 is a side view of FIG. 2.

As shown in FIG. 1, the fan 10 includes a fixed portion 11 having a circular ring or a circular disk and a plurality of blades 12 uniformly arranged on a circumference of the fixed portion 11. The blade 12 has first and second ends opposite to each other. The first end is fixedly connected to the fixed portion 11 and the second end extends in a direction away from the fixed portion 11. A distance between the first end and the second end of the blade 12 is a length L1 of the blade. The blade 12 has a top surface and a bottom surface 121 opposite to each other. The fans in different models or application fields have the bottom surfaces 121 in different widths D1. In some implementations, a blade fixing ring is provided on each of top surfaces of a plurality of the blades 12 of the fan 10.

As shown in FIGS. 2 and 3, the mold device mainly includes a base 30, an upper cover plate 31 detachably mounted on an upper surface of the base 30, and a mold 4 mounted in the upper cover plate 31.

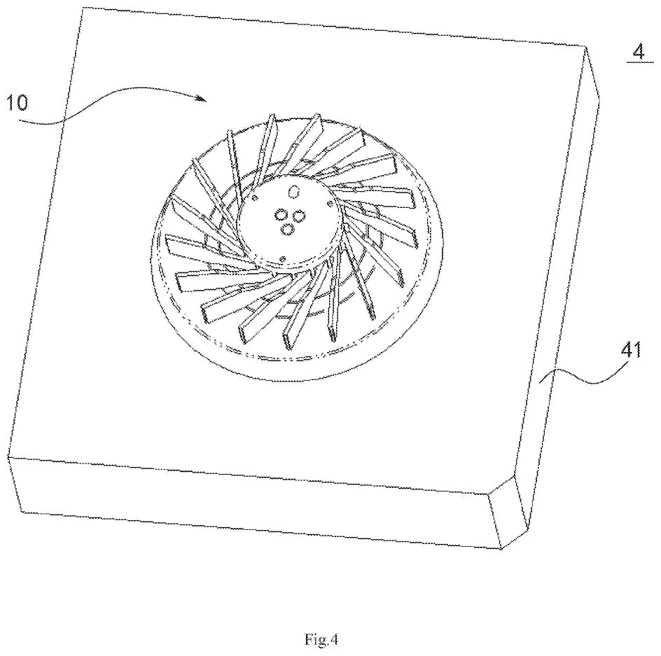

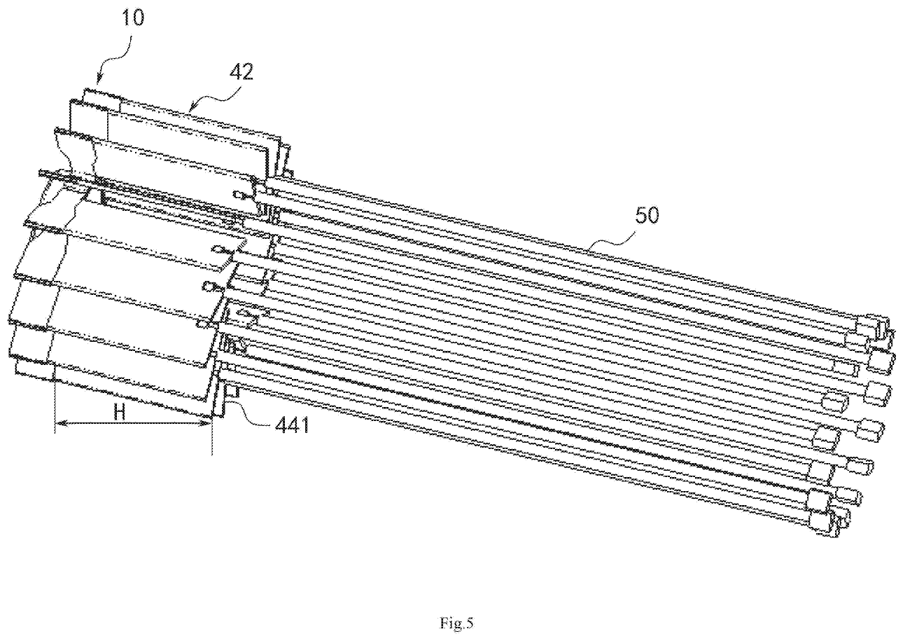

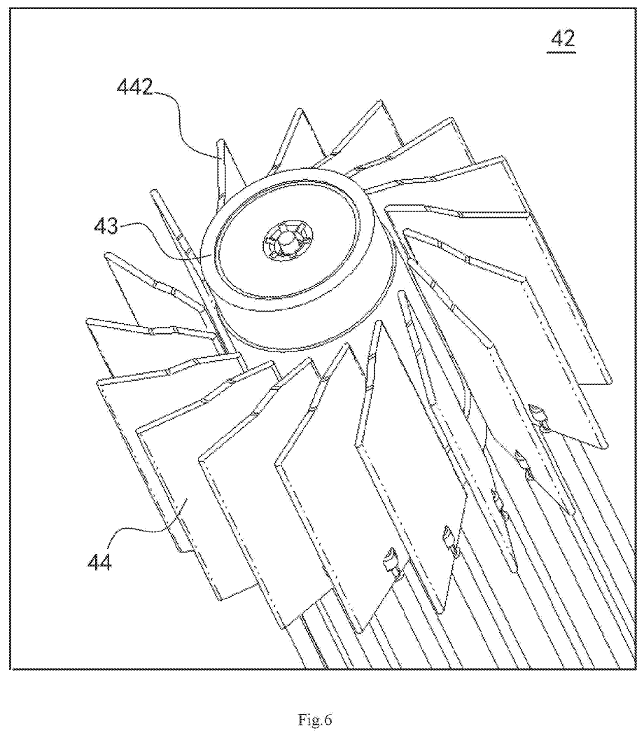

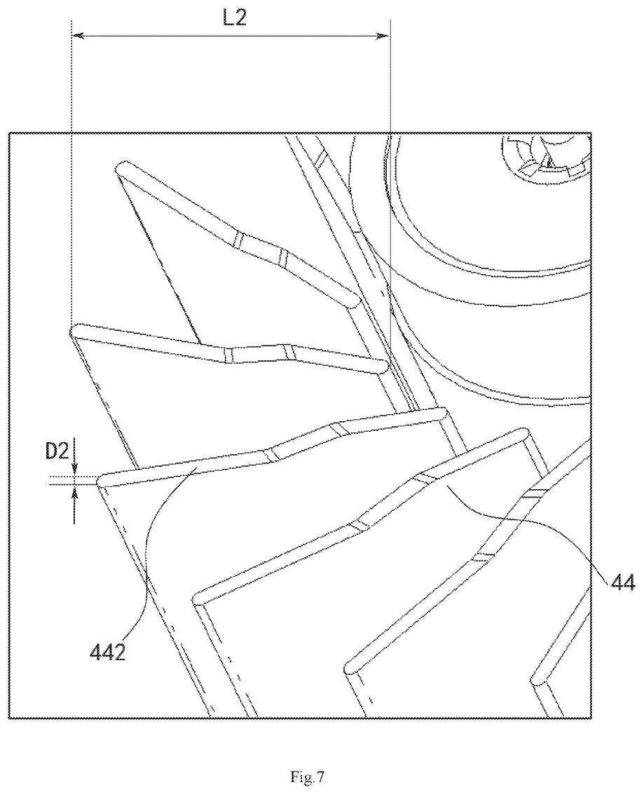

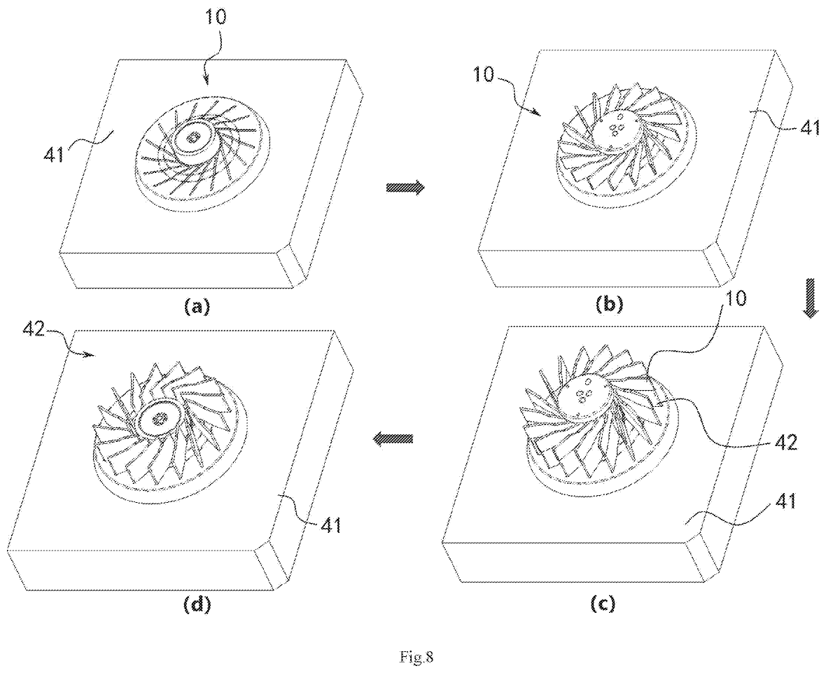

Referring to FIGS. 4 to 8, FIG. 4 is a schematic perspective structural view of an implementation of the mold according to the present disclosure. FIG. 5 is a schematic perspective structural view of an implementation of the ejection structure according to the present disclosure, as viewed from one angle; FIG. 6 is a schematic perspective structural view of an implementation of the ejection structure according to the present disclosure, as viewed from the other angle; FIG. 7 is a partial enlarged view of the ejection structure shown in FIG. 6; FIG. 8 is a schematic view of respective states of a method for manufacturing a fan of the present disclosure.

As shown in FIG. 4, the mold 4 of the present disclosure may be used to manufacture the fan 10 shown in FIG. 1. The mold 4 includes a body 41 and an ejection structure 42. The body 41 has a cavity with a shape matched with the shape of the fan 10.

As shown in FIGS. 5 and 6, the ejection structure 42 includes an ejection portion 43 and a plurality of ejection pins 44 uniformly arranged in a circumferential direction of the ejection portion 43. In this embodiment, the ejection portion 43 is in a shape of a cylinder or a drum, and the structure of the ejection portion 43 may be in other forms, which is not limited thereto. In some other embodiments, the ejection structure 42 may not include the ejection portion 43, but only include a plurality of ejection pins 44 arranged radially in the circumferential direction.

A number of the ejection pins 44 may be identical to a number of the blades 12, and each of the ejection pins 44 has a bottom surface 441 and a top surface opposite to the bottom surface 441. The top surface of the ejection pin 44 is a working surface 442. In one embodiment, the shape of the working surface 442 may be matched with the bottom surface 121 of the blade 12. For example, the working surface 442 of the ejection pin 44 may be a planar surface, a cylindrical surface or a prismatic surface so as to be tightly attached to the bottom surface 121 of the blade 12. In some other embodiments, the shape of the working surface 442 of the ejection pin 44 may be not completely matched with the bottom surface 121 of the blade 12, as long as sufficient ejection force is provided to eject the fan 10 from the cavity of the mold 4.

In some embodiments, the ejection structure 42 further includes push rods 50 mounted between the base 30 and the upper cover plate 31, an ejection pin plate 51, and a drive mechanism (not shown). A number of the push rods 50 may be identical to a number of the ejection pins 44. The push rod 50 has one end fixedly connected to the ejection pin plate 51, and the other end detachably connected to the bottom surface 441 of the ejection pin 44. When the drive mechanism pushes against the ejection pin plate 51, the ejection pin plate 51 may drive the push rod 50 to move.

In the present disclosure, a sum area of the working surfaces 442 of a plurality of the ejection pins 44 is greater than or equal to 40% of a sum area of the bottom surfaces 121 of a plurality of the blades 12 of the fan 10, that is, an area of the working surfaces 442 of all of the ejection pins 44 is at least 40% of an area of the bottom surfaces 121 of a plurality of the blades 12 of the fan 10. Compared with the conventional ejection structure, a contact area of the fan blades and the ejection structure of the present disclosure are significantly increased, such that during the ejection structure 42 ejects the fan 10, the blades 12 of the fan 10 are not easy to deform or break, thus effectively improving a yield. The ejection structure 42 of the present disclosure is particularly suitable for manufacturing fans with fine blades, such as the fans having a blade bottom with a width D1 less than or equal to 0.4 mm or 0.35 mm or 0.3 mm. Correspondingly, a width D2 of the ejection pin 44 is less than or equal to 0.4 mm or 0.35 mm or 0.3 mm or even less than or equal to 0.25 mm or 0.2 mm.

In this embodiment, a height H of the ejection pin 44 is 40 mm. However, the present disclosure is not limited thereto. In some other embodiments, the height H may be appropriately modified according to factors such as size of the fan to be ejected, for example, an axial thickness of the fan, and different application situations. Generally, the height H of the ejection pin 44 is available within a range of 35 mm to 45 mm. Generally speaking, the height H of the ejection pin 44 may be greater than the axial thickness of the blade 12, which is more favorable for ejecting the fan 10 from the cavity of the mold 4.

In the present disclosure, a ratio of the sum area of the working surfaces 442 of a plurality of the ejection pins 44 to the sum area of the bottom surfaces 121 of a plurality of the blades 12 of the fan 10 is not limited to 40%, for example, the sum area of the working surfaces 442 of a plurality of the ejection pins 44 is greater than or equal to 50%, 60%, 70%, 80%, 90%, etc. of the sum area of the bottom surfaces 121 of a plurality of the blades 12 of the fan 10. The greater a value of the ratio is, the larger the contact area of the ejection pin 44 and the fan blade 12 is, such that the blades 12 of the fan 10 are less likely to deform or break during the ejection structure 42 ejecting the fan 10.

When the sum area of the working surfaces 442 of a plurality of the ejection pins 44 is equal to the sum area of the bottom surfaces 121 of a plurality of the blades 12 of the fan 10. That is, the area of the working surface 442 of each of the ejection pins 44 is equal to the area of the bottom surface 121 of each of the blades 12. So that the bottom surface 121 of each of the fan blades 12 is in contact with the working surface 442 of each of the ejection pins 44, as such, all of the fan blades 12 are supported by the ejection pins 44 during the fan 10 is ejected, and thus the fan blades 12 will be difficult to deform or break.

When the sum area of the working surfaces 442 of a plurality of the ejection pins 44 is less than the sum area of the bottom surfaces 121 of a plurality of the blades 12 of the fan 10. In order to ensure that the areas of the bottom surfaces 121 of the respective blades 12 in contact with the working surfaces 442 of the ejection pins 44 are as same as possible, the areas of the working surfaces 442 of the respective ejection pins 44 are allowed to be the same. For example, the area of the working surface 442 of each of the ejection pins 44 is greater than or equal to 50%, 60%, 70%, 80% or 90%, etc. of the area of the bottom surface 121 of each of the blades 12.

In some other embodiments, when the sum area of the working surfaces 442 of a plurality of the ejection pins 44 is less than the sum area of the bottom surfaces 121 of a plurality of the blades 12 of the fan 10, in the radial direction of the fan 10, the length L2 of a part of the ejection pins 44 is identical to the length L1 of the blades 12, and the length of the other part of the ejection pins 44 may be different from the length of the blades 12.

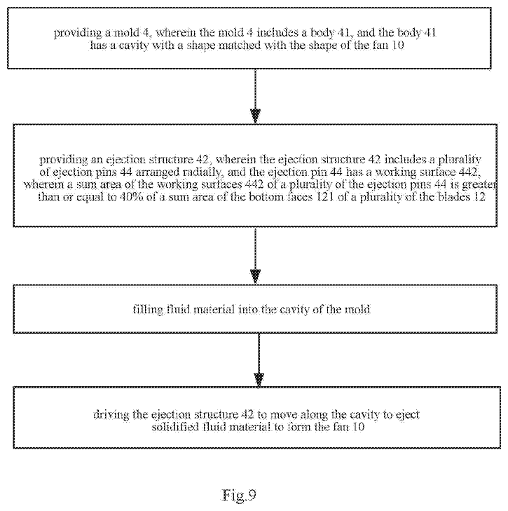

Referring to FIGS. 8 and 9, FIG. 8 is a schematic view of respective states in the method for manufacturing a fan of the present disclosure. FIG. 9 is a flow chart of the method for manufacturing a fan of the present disclosure.

As shown in FIGS. 8 and 9, the manufacturing method of the fan 10 of the present disclosure includes:

providing a mold 4, wherein the mold 4 includes a body 41, and the body 41 has a cavity with a shape matched with the shape of the fan 10;

providing an ejection structure 42, wherein the ejection structure 42 includes a plurality of ejection pins 44 arranged radially, and the ejection pin 44 has a working surface 442, wherein a sum area of the working surfaces 442 of a plurality of the ejection pins 44 is greater than or equal to 40% of a sum area of the bottom surfaces 121 of a plurality of the blades 12;

filling fluid material into the cavity of the mold 4;

driving the ejection structure 42 to move along the cavity to eject solidified fluid material to form the fan 10.

FIG. 8 (a) shows a state in which the fan 10 has not been ejected but being located in the mold 4, FIG. 8 (b) shows a state in which the fan 10 has been ejected, FIG. 8(c) shows a state in which the fan 10 has been further ejected, and FIG. 8(d) shows a state in which a finished fan 10 has been removed.

The present disclosure provides a mold, an ejection structure thereof and a manufacturing method of fan, which are particularly suitable for manufacturing thin fans, such as fans with a blade width less than or equal to 0.4 mm. Of course, the present disclosure is not limited thereto, and a normal fan may also be manufactured.

Relative terms such as “upper” or “lower”, “front” or “rear” may be used in the above implementations to describe relative relation of one component relative to another element(s). It should be appreciated that if the referenced device is inversed upside down, the component indicated as being the “upper” or “lower”, “front” or “rear” side would become the component on the “lower” or “upper”, “rear” or “front” side. The terms “a”, “an”, “the”, “said” and “at least one”, are used to express the presence of one or more the element/ constitute/ or the like. The terms “comprise”, “include” and “have” are intended to be inclusive, and mean there may be additional elements/ constituents/ or the like other than the listed elements/ constituents/ or the like. The “first” and “second” are used only as marks, and are not numerical restriction to the objects.

It should be understood that this disclosure would never be limited to the detailed construction and arrangement of components as set forth in this specification. The present disclosure has other implementations that are able to be practiced or carried out in various ways. The foregoing variations and modifications fall within the scope of this disclosure. It should be understood that the present disclosure would contain all alternative combination of two or more individual features as mentioned or distinguished from in the text and/or in the drawings. All of these different combinations constitute a number of alternative aspects of the present disclosure. The implementations as illustrated in this specification are the best modes known to achieve the present disclosure and will enable the person skilled in the art to realize the present disclosure.

What is claimed is:

1. A mold for manufacturing a fan, wherein the fan comprises a fixed portion and a plurality of blades connected to the fixed portion, each of the blades has a bottom surface, the mold comprising:
a body having a cavity with a shape matched with a shape of the fan, and
an ejection structure comprising a plurality of ejection pins radially arranged, each of the ejection pins has a working surface, and a sum area of the working surfaces of the ejection pins is greater than or equal to 40% of a sum area of the bottom surfaces of the blades.

2. The mold of claim 1, wherein the area of the working surface of each of the ejection pins is greater than or equal to 40% of the area of the bottom surface of each of the blades.

3. The mold of claim 1, wherein the area of the working surface of each of the ejection pins is greater than or equal to 80% of the area of the bottom surface of each of the blades.

4. The mold of claim 1, wherein the area of the working surface of each of the ejection pins is equal to the area of the bottom surface of each of the blades.

5. The mold of claim 1, wherein a number of the ejection pins is identical to a number of the blades.

6. The mold of claim 1, wherein a length of at least a part of the ejection pins is identical to a length of the blades in a radial direction of the fan.

7. The mold of claim 1, wherein the working surface of the ejection pin is planar surface, cylindrical surface or prismatic surface.

8. The mold of claim 1, wherein a width of the ejection pin is 0.4 mm or less.

9. The mold of claim 1, wherein a height of the ejection pin is 35 mm to 45 mm.

10. The mold of claim 1, wherein the ejection structure further comprises a plurality of push rods, and one ends of the push rods are detachably connected to the ejection pins, respectively.

11. The mold of claim 10, wherein the ejection structure further comprises an ejection pin plate fixedly connected to the other end of the push rods.

12. The mold of claim 1, wherein the ejection structure further comprises an ejection portion, and a plurality of the ejection pins are arranged along a circumferential direction of the ejection portion.

13. An ejection structure for manufacturing a fan, wherein the fan comprises a fixed portion and a plurality of blades connected to the fixed portion, each of the blades has a bottom surface, wherein the ejection structure comprising:
a plurality of ejection pins radially arranged, each of the ejection pins has a working surface, and a sum area of the working surfaces of the ejection pins is greater than or equal to 40% of a sum area of the bottom surfaces of the blades.

14. The ejection structure of claim 13, wherein the area of the working surface of each of the ejection pins is greater than or equal to 40% of the area of the bottom surface of each of the blades.

15. The ejection structure of claim 13, wherein the area of the working surface of each of the ejection pins is greater than or equal to 80% of the area of the bottom surface of each of the blades.

16. The ejection structure of claim 13, wherein the area of the working surface of each of the ejection pins is equal to the area of the bottom surface of each of the blades.

17. The ejection structure of claim 13, wherein a number of the ejection pins is identical to a number of the blades.

18. The ejection structure of claim 13, wherein a length of at least a part of the ejection pins is identical to a length of the blades in a radial direction of the fan.

19. The ejection structure as claimed in claim 13, wherein the working surface of the ejection pins is planar surface, cylindrical surface or prism surface.

20. The ejection structure as claimed in claim 13, wherein a width of the ejection pin is 0.4 mm or less.

21. The ejection structure of claim 13, wherein a height of the ejection pin is 35 mm to 45 mm.

22. The ejection structure of claim 13, wherein the ejection structure further comprises a plurality of push rods, and one ends of the push rods are detachably connected to each of the ejection pins, respectively.

23. The ejection structure of claim 22, wherein the ejection structure further comprises an ejection pin plate fixedly connected to the other end of each of the push rods.

24. The ejection structure of claim 13, wherein the ejection structure further comprises an ejection portion, and a plurality of the ejection pins are arranged along a circumferential direction of the ejection portion.

25. A manufacturing method of fan, the fan comprises a fixed portion and a plurality of blades connected to the fixed portion, each of the blades has a bottom surface, wherein the method of manufacturing the fan comprises:
providing a mold, wherein the mold comprises a body, and the body has a cavity with a shape matched with a shape of the fan;
providing an ejection structure, wherein the ejection structure comprises a plurality of ejection pins radially arranged, each of the ejection pins has a working surface, and a sum area of the working surfaces of the ejection pins is greater than or equal to 40% of a sum area of the bottom surfaces of the blades;
filling fluid material into the cavity of the mold;
driving the ejection structure to move along the cavity to eject a solidified fluid material to form a fan.
